(19) United States
(12) Patent Application Publication
(10) Pub. No.: US 2004/0233680 A1
(43) Pub. Date: Nov. 25, 2004

(54) Gas-controlled floating structure for bubble tubes

(76) Inventor: Chun-Teng Lee, Hsin Chu City (TW)

Correspondence Address: CHUN-TENG LEE, P.O. BOX 7-288, TAIPEI, TW

(21) Appl. No.: 10/441,684

(22) Filed: May 21, 2003

(51) Int. Cl. F17C 1/00

(52) U.S. Cl. 362/562

(57) ABSTRACT

The present invention provides a gas-controlled floating structure for bubble tubes. It is related to a plastic disk composed of a ring and a cover. On the rim of the ring is a plurality of airflow grooves arranged in an equidistant manner. In the bottom of the cover is a concave air storage chamber. When the plastic disk is fitted into a bubble tube, the concave air storage chamber will be facing the tube base next to the lampshade, while keeping a suitable distance away from the arc-shaped surface of the tube base. Once the light bulb under the tube base senses the heat, the arc-shaped surface of the tube base will be heated up by the covering disk. Bubbles appear, whenever hot air starts to accumulate in the concave air storage chamber. The emerging bubbles then rise gradually through the equidistant airflow grooves installed on the rim of the ring. Eventually, owing to the accumulation of hot air, bubbles will be flowing in an esthetic manner.

### BACKGROUND OF THE INVENTION

The invention of light bulb enables human beings to conquer the dark and have limitless visions, and is further contributed to our well-being. Along with social and culture evolution, a trail of inventions on light bulbs, including Christmas bulbs, neon bulbs, car bulbs, etc., are invented for decoration purpose and further contributed to human beings'splendid lifestyle. The conventional decorative light bulbs, however, are boring and lifeless and that is why bubble bulbs start to emerge. The present technique for generating bubbles in a bubble light bulb involves heating up transparent particles in a chemical solution found in the bottom of the light bulb, and the rising bubbles pass through the gaps among the transparent particles. However, old bubble light bulbs are often crippled on account of the drawback that the transparent particles get stickier and stickier and thus the aforesaid gaps become narrower and narrower, until the passage is jammed and no bubble is generated.

### SUMMARY OF THE INVENTION

The primary purpose of the present invention is to provide a gas-controlled floating structure for bubble tubes, and to be specific is by combining a ring and a cover to accumulate hot air, bubbles will be flowing in an esthetic manner.

The secondary purpose of the present invention is to provide a gas-controlled floating structure for bubble tubes, wherein a plurality of equidistant airflow grooves are arranged on the rim of the ring, and there is a concave air storage chamber in the bottom of the cover. When the plastic disk is fitted into a bubble fluorescent tube, the concave air storage chamber will be facing the tube base next to the lampshade, while keeping a suitable distance away from the arc-shaped surface of the tube base.

Another purpose of the present invention is also to provide a gas-controlled floating structure for bubble tubes, wherein the arc-shaped surface of the tube base will be heated up by the covering disk whenever the light bulb under the tube base senses the heat, and bubbles appear as soon as hot air starts to accumulate in the concave air storage chamber. As a result, emerging bubbles then rise gradually through the equidistant airflow grooves installed on the rim of the ring.

### BRIEF DESCRIPTION OF THE DRAWINGS

FIG. 1 is a structure diagram illustrates the invention of gas-controlled floating structure for bubble tubes;

FIG. 2 is diagram illustrates the assembly components of the invention;

FIG. 3 is diagram illustrates how the invention senses the heat; and

FIG. 4 is a diagram illustrates how the air-storage chamber of the cover generates bubbles.

### DETAILED DESCRIPTION OF THE PREFERRED EMBODIMENT

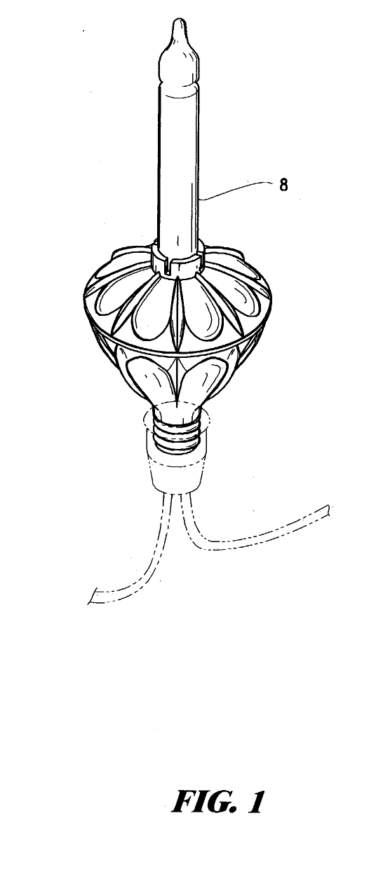

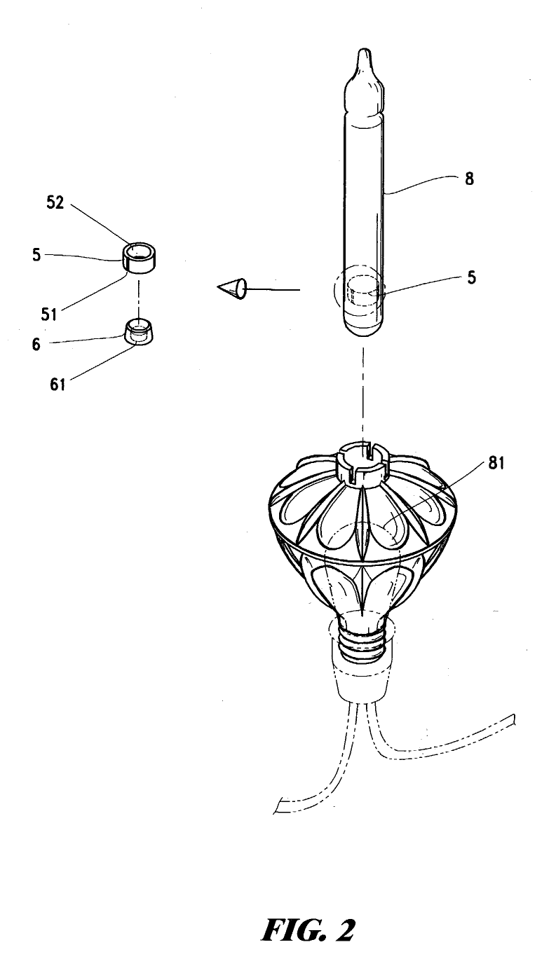

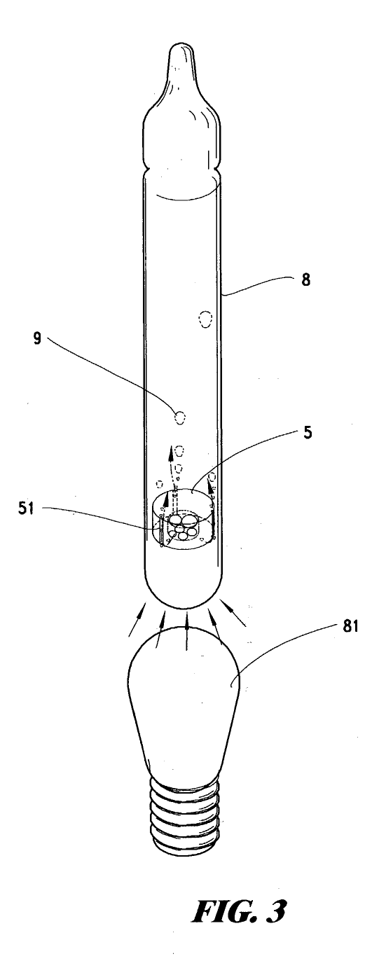

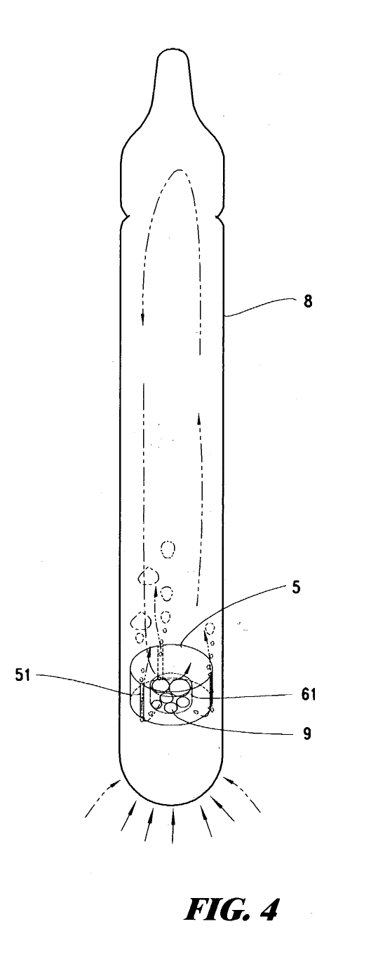

Please refer to FIGS. 1 to 4, the present invention is related to a gas-controlled floating structure for bubble tubes. It is related to a plastic disk composed of a circular ring and a circular cover. On the rim of the circular, ring 5 are a plurality of airflow grooves 51 arranged in an equidistant manner. There is an open space 52 at the center of the ring 5. In the bottom of the circular cover 6 is a concave heat-accumulating chamber 61. The cover 6 is fitted into the open space at the center of the ring 5, forming a plastic disk. The plastic disk is then fitted into a fluorescent tube 8 and thus it is installed in the bottom of the tube along with a chemical solution. The concave air storage chamber is facing the tube base next to the lampshade, while keeping a suitable distance away from the arc-shaped surface of the tube base. Once the light bulb 81 under the tube base senses the heat, the chemical solution near the arc-shaped surface of the tube base will be heated up. Bubbles 9 appear, whenever hot air starts to accumulate in the concave air storage chamber. The emerging bubbles then rise gradually through the radially equidistant airflow grooves 51 installed on the rim of the ring. Eventually, owing to the accumulation of hot air, bubbles will be flowing in an esthetic manner.

While the invention has been described by means of specific embodiments, numerous modifications and variations could be made thereto by those skilled in the art without departing from the scope and spirit of the invention set forth in the claims.

What is claimed is:

1. A gas-controlled floating structure for bubble tubes, wherein the rim of its ring having a plurality of equidistant, concave airflow grooves, and there is an open space at the center of said ring; in the bottom of the circular cover is a concave heat-accumulating chamber; said cover is fitted into said open space at the center of said ring, forming a plastic disk; said plastic disk is then fitted into a fluorescent tube and thus it is installed in the bottom of said tube a,long with a chemical solution; said concave heat-accumulating chamber is facing the base of said tube, while keeping a suitable distance away from the arc-shaped surface of the base of said tube; bubbles appear, whenever hot air begins to accumulate in said concave heat-accumulating chamber; emerging bubbles then rise gradually through said plurality of radially equidistant airflow grooves installed on the rim of said ring; eventually, bubbles will be flowing in an esthetic manner.
